(19) United States
(12) Patent Application Publication
(10) Pub. No.: US 2010/0092761 A1
(43) Pub. Date: Apr. 15, 2010

(54) NANOPARTICLES

(76) Inventors: Matthias Koch, Wiesbaden (DE); Gerhard Jonschker, Heppenheim (DE); Sabine Renker, Limburg (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/302,150

(22) PCT Filed: May 8, 2007
(86) PCT No.: PCT/EP2007/004034

§ 371 Date: Apr. 13, 2009

(30) Foreign Application Priority Data
May 24, 2006 (DE) 10 2006 024 288.2

(51) Int. Cl. C08K 3/36; B01J 13/02; B32B 5/16; F21V 9/06

(52) U.S. Cl. 428/328; 427/213.3; 427/213.31; 428/372; 252/588; 524/493

(57) ABSTRACT

The invention relates to nanoparticles, in particular surface-modified nanoparticles, having an average particle size, determined by means of particle correlation spectroscopy (PCS) or transmission electron microscope, in the range from 3 to 50 nm, dispersed in an organic solvent, characterised in that they are obtainable by a process in which one or more precursors of the nanoparticles are reacted with a compound M₃₋ₓ[O₃₋ₓSiR₁₊ₓ] in an organic solvent to give the nanoparticles, where x stands for an integer selected from 0, 1 or 2, M stands for H, Li, Na or K, and all R each, independently of one another, stand for a branched or unbranched, saturated or unsaturated hydrocarbon radical having 1 to 28 C atoms, in which one or more C atoms may be replaced by O, and to the use thereof for UV protection in polymers.

The invention relates to nanoparticles, in particular surface-modified nanoparticles, to a process for the production of such particles, and to the use thereof for UV protection.

The incorporation of inorganic nanoparticles into a polymer matrix can influence not only the mechanical properties, such as, for example, impact strength, of the matrix, but also modifies its optical properties, such as, for example, wavelength-dependent transmission, colour (absorption spectrum) and refractive index. In mixtures for optical applications, the particle size plays an important role since the addition of a substance having a refractive index which differs from the refractive index of the matrix inevitably results in light scattering and ultimately in light opacity. The drop in the intensity of radiation of a defined wavelength on passing through a mixture shows a high dependence on the diameter of the inorganic particles.

In addition, a very large number of polymers are sensitive to UV radiation, meaning that the polymers have to be UV-stabilised for practical use. Many organic UV filters which would in principle be suitable here as stabilisers are unfortunately themselves not photostable, and consequently there continues to be a demand for suitable materials for long-term applications.

Suitable substances consequently have to absorb in the UV region, appear as transparent and colourless as possible in the visible region and be straightforward to incorporate into polymers. Although numerous metal oxides absorb UV light, they can, however, for the above-mentioned reasons only be incorporated with difficulty into polymers without impairing the mechanical or optical properties in the region of visible light.

The development of suitable nanomaterials for dispersion in polymers requires not only control of the particle size, but also of the surface properties of the particles. Simple mixing (for example by extrusion) of hydrophilic particles with a hydrophobic polymer matrix results in in-homogeneous distribution of the particles throughout the polymer and additionally in aggregation thereof. For homogeneous incorporation of inorganic particles into polymers, their surface must therefore be at least hydrophobically modified. In addition, the nanoparticulate materials, in particular, exhibit a great tendency to form agglomerates, which also survive subsequent surface treatment.

The literature contains various approaches to providing suitable particles:

International Patent Application WO 2005/070820 describes polymer-modified nanoparticles which are suitable as UV stabilisers in polymers. These particles can be obtained by a process in which in a step a) an inverse emulsion comprising one or more water-soluble precursors of the nanoparticles or a melt is prepared with the aid of a random copolymer of at least one monomer containing hydrophobic radicals and at least one monomer containing hydrophilic radicals, and in a step b) particles are produced. These particles are preferably ZnO particles having a particle size of 30 to 50 nm with a coating of a copolymer essentially consisting of lauryl methacrylate (LMA) and hydroxyethyl methacrylate (HEMA). The ZnO particles are produced, for example, by basic precipitation from an aqueous zinc acetate solution.

International Patent Application WO 2000/050503 describes a process for the preparation of zinc oxide gels by basic hydrolysis of at least one zinc compound in alcohol or an alcohol/water mixture, which is characterised in that the precipitate initially forming during the hydrolysis is allowed to mature until the zinc oxide has completely flocculated out, this precipitate is then compacted to give a gel and separated off from the supernatant phase.

International Patent Application WO 2005/037925 describes the production of ZnO and ZnS nanoparticles which are suitable for the preparation of luminescent plastics. The ZnO particles are precipitated from an ethanolic solution of zinc acetate by means of ethanolic NaOH solution and allowed to age for 24 hours before the ethanol is replaced by butanediol monoacrylate.

International Patent Application WO 2004/106237 describes a process for the production of zinc oxide particles in which a methanolic potassium hydroxide solution having a hydroxide ion concentration of 1 to 10 mol of OH per kg of solution is added to a methanolic solution of zinc carboxylic acid salts having a zinc ion concentration of 0.01 to 5 mol of Zn per kg of solution in a molar OH:Zn ratio of 1.5 to 1.8 with stirring, and the precipitation solution obtained when the addition is complete is matured at a temperature of 40 to 65° C. over a period of 5 to 50 min and finally cooled to a temperature of ≦25° C., giving particles which are virtually spherical.

The dissertation by K. Feddern (“Synthese and optische Eigenschaften von ZnO Nanokristallen” [Synthesis and Optical Properties of ZnO Nanocrystals], University of Hamburg, June 2002) describes the production of ZnO particles from zinc acetate by means of LiOH in isopropanol. The particles can be coated with SiO₂ here in a similar manner to the so-called “Stöber process” by reaction with tetraethoxysilane in the presence of ammonia, but cloudy dispersions form here. The coating of dispersed ZnO particles with orthophosphate or tributyl phosphate or diisooctylphosphinic acid is also described here.

German Patent Applications DE 102005056621 and DE 102005056622 describe processes for the production of nanoparticles in which, in a step a), one or more precursors of the nanoparticles are converted to the nanoparticles in an organic solvent, and, in a step b), the growth of the nanoparticles is terminated by addition of at least one modifier, which can be a copolymer comprising at least one monomer containing hydrophobic radicals and at least one monomer containing hydrophilic radicals or an alkoxysilane, when the absorption edge in the UV/VIS spectrum of the reaction solution has reached the desired value, and the use thereof for UV protection in polymers.

There continues to be a demand for suitable surface modifications for nanoparticles and production processes which allow precise setting of the absorption and scattering behaviour and control of the particle size.

It would therefore be desirable to have a process with which small nanoparticles can be produced directly with suitable surface modification, if possible without agglomerates, where the particles obtained in this way absorb radiation in the UV region in dispersions, but scarcely absorb or scatter radiation in the visible region, and are stable for an extended period in this state.

Surprisingly, it has now been found that this is possible in one step if the particle formation and surface modification are initiated by a siloxy compound.

The present invention therefore relates firstly to nanoparticles having an average particle size, determined by means of particle correlation spectroscopy (PCS), in the range from 3 to 50 nm, dispersed in an organic solvent, characterised in that they are obtainable by a process in which one or more precursors of the nanoparticles are reacted with a compound M₃₋ₓ[O₃₋ₓSiR₁₊ₓ] in an organic solvent to give the nanoparticles, where x stands for an integer selected from 0, 1 or 2, M stands for H, Li, Na or K, and all R each, independently of one another, stand for a branched or unbranched, saturated or unsaturated hydrocarbon radical having 1 to 28 C atoms, in which one or more C atoms may be replaced by O.

The particles according to the invention are distinguished by high absorption in the UV region, particularly preferably in the UV-A region, together with high transparency in the visible region. In contrast to many particle grades known from the prior art, these properties of the particles according to the invention do not change on storage, or only do so to a negligible extent.

In addition, the SiR₁₊ₓ groups on the particle surface reduce the photocatalytic activity of the particles or photocatalytic degradation thereof. In a preferred embodiment of the present invention, in particular after modification of the particles by further layers, the photocatalytic activity of the particles is significantly reduced (as described in Example 4).

In addition, the production process according to the invention allows economical production of the particles since higher solids contents can be achieved in the product suspension than on use of conventional hydroxide bases. In addition, the addition of the compound M₃₋ₓ[O₃₋ₓSiR₁₊ₓ] enables better stabilisation of the particles to be achieved over a broader size range, meaning that the time window for application of the modifying or compatibilising layers is significantly larger. In the present application, compatibilising means functionalisation of the particles in such a way that transfer into organic, hydrophobic solvents, as is required for many applications (for example in surface coatings), becomes possible. This can be achieved, for example, by suitable hydrophobic silanes.

In preferred embodiments of the present invention, the nanoparticles are particles essentially consisting of oxides or hydroxides of silicon, cerium, cobalt, chromium, nickel, zinc, titanium, iron, yttrium, zirconium or mixtures thereof, where the particles are preferably zinc oxide or cerium oxide particles or mixed oxide particles comprising at least one of these constituents.

The particles according to the invention preferably have an average particle size, determined by means of particle correlation spectroscopy (PCS) or by a transmission electron microscope, of 5 to 20 nm, preferably 7 to 15 nm. In specific, likewise preferred embodiments of the present invention, the distribution of the particle sizes is narrow, i.e. the d50 value, and in particularly preferred embodiments even the d90 value, are preferably in the above-mentioned ranges from 5 to 15 nm, or even from 7 to 12 nm.

In a variant of the invention, it is preferred for the particles to have a further surface modification, preferably a silica coating and/or a hydrophobic modification.

For the purposes of the present invention, silica means a material essentially consisting of silicon dioxide and/or silicon hydroxide, where some of the Si atoms may also carry organic radicals which were already present in the modifiers.

Surface modifiers for hydrophobic modification are selected, for example, from the group of organofunctional silanes, quaternary ammonium compounds, phosphonates, phosphonium and sulfonium compounds or mixtures thereof. A preferred surface modifier is an organofunctional silane as described in greater detail below.

In a further variant of the invention, it is preferred for the particles according to the invention to have a silica coating and additionally to have been modified further by means of a surface modifier selected from the group of organofunctional silanes, quaternary ammonium compounds, phosphonates, phosphonium and sulfonium compounds or mixtures thereof. A preferred surface modifier is an organofunctional silane as described in greater detail below.

The present invention furthermore relates to a corresponding production process, i.e. a process for the production of nanoparticles having an average particle size in the range from 3 to 50 nm, dispersed in an organic solvent, characterised in that one or more precursors of the nanoparticles are reacted with a compound M₃₋ₓ[O₃₋ₓSiR₁₊ₓ] in an organic solvent to give the nanoparticles, where x stands for an integer selected from 0, 1 or 2, M stands for H, Li, Na or K, and all R each, independently of one another, stand for a branched or unbranched, saturated or unsaturated hydrocarbon radical having 1 to 28 C atoms, in which one or more C atoms may be replaced by O.

Precursors of the inorganic nanoparticles which can be employed are accordingly, for example, water-soluble metal compounds, preferably silicon, cerium, cobalt, chromium, nickel, zinc, titanium, iron, yttrium and/or zirconium compounds. Preferred precursors are zinc salts of carboxylic acids, for example zinc acetate or halides. Mixed oxides can be obtained in a simple manner by suitable mixing of the corresponding precursors. The selection of suitable precursors presents the person skilled in the art with no difficulties; all compounds which are suitable for precipitation of the corresponding target compounds from aqueous solution are suitable. An overview of suitable precursors for the preparation of oxides is given, for example, in Table 6 in K. Osseo-Asare “Microemulsion-mediated Synthesis of nanosize Oxide Materials” in: Kumar P., Mittal K L, (editors), Handbook of microemulsion science and technology, New York: Marcel Dekker, Inc., pp. 559-573, the contents of which expressly belong to the disclosure content of the present application.

In an embodiment, a base MOH, where M stands for Li, Na or K, can additionally be employed, where the proportion of base in the total amount of M₃₋ₓ[O₃₋ₓSiR₁₊ₓ] and base can be up to 99.5%. If an additional base MOH is to be employed, the proportion of base is preferably 10-70 mol %, based on the total amount, or particularly preferably 30-60 mol %.

At least one radical R in the compounds M₃₋ₓ[O₃₋ₓSiR₁₊ₓ] preferably stands for an alkoxy radical having 1 to 27 C atoms, preferably a methoxy or ethoxy radical.

In a further preferred embodiment, x stands for 2 and all R each, independently of one another, stand for methyl or ethyl.

In preferred compounds M₃₋ₓ[O₃₋ₓSiR₁₊ₓ], all R each, independently of one another, stand for methyl, ethyl, methoxy or ethoxy. It may furthermore be preferred in accordance with the invention for M to stand for K. In a variant of the invention, it is furthermore particularly preferred for x to stand for 2 and for the formulae of the said compounds to be correspondingly simplified to M[OSiR₃]. Very particular preference is given here to the use of compounds of the formula K[OSiR₂CH₃], with R as indicated above, where all R preferably stand for methyl.

Further preferred combinations are disclosed in the Claims.

In a further embodiment, the compound M₃₋ₓ[O₃₋ₓSiR₁₊ₓ], where M stands for Li, Na or K, and x and R have a meaning indicated above, is preferably generated in situ from a base MOH and a compound R′₃₋ₓ[O₃₋ₓSiR₁₊ₓ], where R′ denotes an alkyl group having 1 to 16 C atoms, preferably having 1 to 4 C atoms, very particularly preferably ethyl.

In a further variant of the invention, it is preferred, in a further reaction step, for at least one modifier to be added for the production of a silica coating or for a surface modifier selected from the group of organofunctional silanes, quaternary ammonium compounds, phosphonates, phosphonium and sulfonium compounds to be added for the production of a hydrophobic shell.

The modifier which is a precursor of silica is preferably a trialkoxysilane or a tetraalkoxysilane, where alkoxy preferably stands for methoxy or ethoxy, particularly preferably for methoxy. Particular preference is given in accordance with the invention to the use of tetramethoxysilane (TMOS) as modifier.

The modifier is generally added 1 to 50 min after commencement of the reaction, preferably 10 to 40 min after commencement of the reaction and particularly preferably after about 30 min.

In a particularly preferred variant of the process according to the invention, after the application of a silica coating, at least one surface modifier is added in a further reaction step, where the modifier is preferably an organofunctional silane, quaternary ammonium compound, phosphonate, phosphonium or sulfonium compound.

The preferred treatment with a surface modifier enables the nanoparticles to be isolated from the dispersions with virtually no agglomerates since the individual particles form directly in coated form. In addition, the nanoparticles obtainable by this method can be redispersed particularly simply and uniformly, where, in particular, undesired impairment of the transparency of such dispersions in visible light can be substantially avoided.

Suitable surface modifiers (modifiers) are, for example, organofunctional silanes, quaternary ammonium compounds, phosphonates, phosphonium and sulfonium compounds or mixtures thereof. The surface modifiers are preferably selected from the group of the organofunctional silanes.

The surface modifier requirements described are, in accordance with the invention, satisfied, in particular, by an adhesion promoter which carries two or more functional groups. A group of the adhesion promoter reacts chemically with the oxide surface of the nanoparticle. Alkoxysilyl groups (for example methoxy- and ethoxysilanes), halosilanes (for example chlorosilanes) or acidic groups of phosphoric acid esters or phosphonic acids and phosphonic acid esters come into consideration here. The groups described are linked to a second functional group via a relatively long spacer. This spacer is a nonreactive alkyl chain, siloxane, polyether, thioether or urethane or a combination of these groups of the general formula (C,Si)ₙHₘ(N,O,S)ₓ, where n=1-50, m=2-100 and x=0-50. The functional group is preferably an acrylate, methacrylate, vinyl, amino, cyano, isocyanate, epoxide, carboxyl or hydroxyl group.

Silane-based surface modifiers are described, for example, in DE 40 11 044 C2. Phosphoric acid-based surface modifiers are obtainable, inter alia, as Lubrizol® 2061 and 2063 from LUBRIZOL (Langer & Co.). Suitable silanes are, for example, C3 to C18-alkyltrimethoxysilanes, vinyltrimethoxysilane, aminopropyltriethoxysilane, N-ethylamino-N-propyldimethoxysilane, isocyanatopropyltriethoxysilane, mercapto-propyltrimethoxysilane, vinyltriethoxysilane, vinylethyldichlorosilane, vinylmethyldiacetoxysilane, vinylmethyldichlorosilane, vinylmethyldiethoxysilane, vinyltriacetoxysilane, vinyltrichlorosilane, phenylvinyldiethoxysilane, phenylallyldichlorosilane, 3-isocyanatopropoxytriethoxysilane, methacryloxypropenyltrimethoxysilane, 3-methacryloxypropyltrimethoxysilane, 3-glycidyloxypropyltrimethoxysilane, 1,2-epoxy-4-(ethyltriethoxysilyl)cyclohexane, 3-acryloxypropyltrimethoxysilane, 2-methacryloxyethyltrimethoxysilane, 2-acryloxyethyltrimethoxysilane, 3-methacryloxypropyltriethoxysilane, 3-acryloxypropyltrimethoxysilane, 2-methacryloxyethyltriethoxysilane, 2-acryloxyethyltriethoxysilane, 3-methacryloxypropyltris(methoxyethoxy)silane, 3-methacryloxypropyltris(butoxyethoxy)silane, 3-methacryloxypropyltris(propoxy)silane, 3-methacryloxypropyltris(butoxy)silane, 3-acryloxypropyltris(methoxyethoxy)silane, 3-acryloxypropyltris(butoxyethoxy)silane, 3-acryloxypropyltris(propoxy)-silane, 3-acryloxypropyltris(butoxy)silane. 3-Methacryloxypropyltrimethoxysilane and hexadecyltrimethoxysilane are particularly preferred. These and other silanes are commercially available, for example, from ABCR GmbH & Co., Karlsruhe, or from Sivento Chemie GmbH, Düsseldorf. The surface modifier used, as described above, is very particularly preferably hexadecyltrimethoxysilane.

Vinylphosphonic acid and diethyl vinylphosphonate may also be mentioned here as adhesion promoters (manufacturer: Hoechst AG, Frankfurt am Main).

It is also particularly preferred here for the surface modifier to be an amphiphilic silane of the general formula (R)₃Si—S_{P}-Aₕₚ-B_{hb}, where the radicals R may be identical or different and represent hydrolytically removable radicals, S_{P} denotes either —O— or straight-chain or branched alkyl having 1-18 C atoms, straight-chain or branched alkenyl having 2-18 C atoms and one or more double bonds, straight-chain or branched alkynyl having 2-18 C atoms and one or more triple bonds, saturated, partially or fully unsaturated cycloalkyl having 3-7 C atoms, which may be substituted by alkyl groups having 1-6 C atoms, Aₕₚ denotes a hydrophilic block, B_{hb} denotes a hydrophobic block, and where at least one reactive functional group is preferably bonded to Aₕₚ and/or B_{hb}.

Particular preference is given here to the use of 2-(2-hexylethoxy)ethyl(3-trimethoxysilanylpropyl)carbamate.

The amphiphilic silanes contain a head group (R)₃Si, where the radicals R may be identical or different and represent hydrolytically removable radicals. The radicals R are preferably identical.

Suitable hydrolytically removable radicals are, for example, alkoxy groups having 1 to 10 C atoms, preferably having 1 to 6 C atoms, halogens, hydrogen, acyloxy groups having 2 to 10 C atoms and in particular having 2 to 6 C atoms or NR′₂ groups, where the radicals R′ may be identical or different and are selected from hydrogen and alkyl having 1 to 10 C atoms, in particular having 1 to 6 C atoms. Suitable alkoxy groups are, for example, methoxy, ethoxy, propoxy or butoxy groups. Suitable halogens are, in particular, Br and Cl. Examples of acyloxy groups are acetoxy and propoxy groups. Oximes are furthermore also suitable as hydrolytically removable radicals. The oximes here may be substituted by hydrogen or any desired organic radicals. The radicals R are preferably alkoxy groups and in particular methoxy or ethoxy groups.

A spacer S_{P} is covalently bonded to the above-mentioned head group and functions as connecting element between the Si head group and the hydrophilic block Aₕₚ and takes on a bridge function for the purposes of the present invention. The group S_{P} is either —O— or straight-chain or branched alkyl having 1-18 C atoms, straight-chain or branched alkenyl having 2-18 C atoms and one or more double bonds, straight-chain or branched alkynyl having 2-18 C atoms and one or more triple bonds, saturated, partially or fully unsaturated cycloalkyl having 3-7 C atoms, which may be substituted by alkyl groups having 1-6 C atoms.

The C₁-C₁₈-alkyl group of S_{P} is, for example, a methyl, ethyl, isopropyl, propyl, butyl, sec-butyl or tert-butyl, furthermore also pentyl, 1-, 2- or 3-methylbutyl, 1,1-, 1,2- or 2,2-dimethylpropyl, 1-ethylpropyl, hexyl, heptyl, octyl, nonyl, decyl, undecyl, dodecyl, tridecyl or tetradecyl group. It may optionally be perfluorinated, for example as difluoromethyl, tetra-fluoroethyl, hexafluoropropyl or octafluorobutyl group.

A straight-chain or branched alkenyl having 2 to 18 C atoms, in which a plurality of double bonds may also be present, is, for example, vinyl, allyl, 2- or 3-butenyl, isobutenyl, sec-butenyl, furthermore 4-pentenyl, isopentenyl, hexenyl, heptynyl, octenyl, —C₉H₁₆, —C₁₀H₁₈ to —C₁₈H₃₄, preferably allyl, 2- or 3-butenyl, isobutenyl, sec-butenyl, furthermore preferably 4-pentenyl, isopentenyl or hexenyl.

A straight-chain or branched alkynyl having 2 to 18 C atoms, in which a plurality of triple bonds may also be present, is, for example, ethynyl, 1- or 2-propynyl, 2- or 3-butynyl, furthermore 4-pentynyl, 3-pentynyl, hexynyl, heptynyl, octynyl, —C₉H₁₄, —C₁₀H₁₆ to —C₁₈H₃₂, preferably ethynyl, 1- or 2-propynyl, 2- or 3-butynyl, 4-pentynyl, 3-pentynyl or hexynyl.

Unsubstituted saturated or partially or fully unsaturated cycloalkyl groups having 3-7 C atoms can be cyclopropyl, cyclobutyl, cyclopentyl, cyclohexyl, cycloheptyl, cyclopentenyl, cyclopenta-1,3-dienyl, cyclohexenyl, cyclohexa-1,3-dienyl, cyclohexa-1,4-dienyl, phenyl, cycloheptenyl, cyclohepta-1,3-dienyl, cyclohepta-1,4-dienyl or cyclohepta-1,5-dienyl groups, which are substituted by C₁- to C₆-alkyl groups.

The spacer group S_{P} is followed by the hydrophilic block Aₕₚ. The latter can be selected from nonionic, cationic, anionic and zwitterionic hydrophilic polymers, oligomers and groups. In the simplest embodiment, the hydrophilic block comprises ammonium, sulfonium or phosphonium groups, alkyl chains containing carboxyl, sulfate or phosphate side groups, which may also be in the form of a corresponding salt, partially esterified anhydrides containing a free acid or salt group, OH-substituted alkyl or cycloalkyl chains (for example sugars) containing at least one OH group, NH- and SH-substituted alkyl or cycloalkyl chains or mono-, di-, tri- or oligoethylene glycol groups. The length of the corresponding alkyl chains can be 1 to 20 C atoms, preferably 1 to 6 C atoms.

The nonionic, cationic, anionic or zwitterionic hydrophilic polymers, oligomers or groups here can be prepared from corresponding monomers by polymerisation by the methods which are generally known to the person skilled in the art. Suitable hydrophilic monomers here contain at least one dispersing functional group selected from the group consisting of
(i) functional groups which can be converted into anions by neutralisers, and anionic groups, and/or
(ii) functional groups which can be converted into cations by neutralisers and/or quaternising agents, and cationic groups, and/or
(iii) nonionic hydrophilic groups.

The functional groups (i) are preferably selected from the group consisting of carboxyl, sulfonyl and phosphonyl groups, acidic sulfuric acid and phosphoric acid ester groups and carboxylate, sulfonate, phosphonate, sulfate ester and phosphate ester groups, the functional groups (ii) are preferably selected from the group consisting of primary, secondary and tertiary amino groups, primary, secondary, tertiary and quaternary ammonium groups, quaternary phosphonium groups and tertiary sulfonium groups, and the functional groups (iii) are preferably selected from the group consisting of omega-hydroxy- and omega-alkoxypoly(alkylene oxide)-1-yl groups.

If not neutralised, the primary and secondary amino groups can also serve as isocyanate-reactive functional groups.

Examples of highly suitable hydrophilic monomers containing functional groups (i) are acrylic acid, methacrylic acid, beta-carboxyethyl acrylate, ethacrylic acid, crotonic acid, maleic acid, fumaric acid and itaconic acid; olefinically unsaturated sulfonic and phosphoric acids and partial esters thereof; and mono(meth)acryloyloxyethyl maleate, mono(meth)acryloyloxyethyl succinate and mono(meth)acryloyloxyethyl phthalate, in particular acrylic acid and methacrylic acid.

Examples of highly suitable hydrophilic monomers containing functional groups (ii) are 2-aminoethyl acrylate and methacrylate and allylamine.

Examples of highly suitable hydrophilic monomers containing functional groups (iii) are omega-hydroxy- and omega-methoxypoly(ethylene oxide)-1-yl, omega-methoxypoly(propylene oxide)-1-yl and omega-methoxypoly(ethylene oxide-co-polypropylene oxide)-1-yl acrylate and methacrylate, and hydroxyl-substituted ethylenes, acrylates and methacrylates, such as, for example, hydroxyethyl methacrylate.

Examples of suitable monomers for the formation of zwitterionic hydrophilic polymers are those in which a betaine structure occurs in the side chain. The side group is preferably selected from —(CH₂)ₘ—(N⁺(CH₃)₂)—(CH₂)ₙ—SO₃⁻, —(CH₂)ₘ—(N⁺(CH₃)₂)—(CH₂)ₙ—PO₃²⁻, —(CH₂)ₘ—(N⁺(CH₃)₂)—(CH₂)ₙ—O—PO₃²⁻ and —(CH₂)ₘ—(P⁺(CH₃)₂)—(CH₂)ₙ—SO₃⁻, where m stands for an integer from the range 1 to 30, preferably from the range 1 to 6, particularly preferably 2, and n stands for an integer from the range 1 to 30, preferably from the range 1 to 8, particularly preferably 3.

It may be particularly preferred here for at least one structural unit of the hydrophilic block to contain a phosphonium or sulfonium radical.

When selecting the hydrophilic monomers, it should be ensured that the hydrophilic monomers containing functional groups (i) and the hydrophilic monomers containing functional groups (ii) are preferably combined with one another in such a way that no insoluble salts or complexes are formed. By contrast, the hydrophilic monomers containing functional groups (i) or containing functional groups (ii) can be combined as desired with the hydrophilic monomers containing functional groups (iii).

Of the hydrophilic monomers described above, the monomers containing functional groups (i) are particularly preferably used.

The neutralisers for the functional groups (i) which can be converted into anions are preferably selected here from the group consisting of ammonia, trimethylamine, triethylamine, tributylamine, dimethylaniline, diethylaniline, triphenylamine, dimethylethanolamine, diethylethanolamine, methyldiethanolamine, 2-aminomethylpropanol, dimethylisopropylamine, dimethylisopropanolamine, triethanolamine, diethylenetriamine and triethylenetetramine, and the neutralisers for the functional groups (ii) which can be converted into cations are preferably selected here from the group consisting of sulfuric acid, hydrochloric acid, phosphoric acid, formic acid, acetic acid, lactic acid, dimethylolpropionic acid and citric acid.

The hydrophilic block is very particularly preferably selected from mono-, di- and triethylene glycol structural units.

The hydrophobic block B_{hb} follows bonded to the hydrophilic block Aₕₚ. The block B_{hb} is based on hydrophobic groups or, like the hydrophilic block, on hydrophobic monomers which are suitable for polymerisation.

Examples of suitable hydrophobic groups are straight-chain or branched alkyl having 1-18 C atoms, straight-chain or branched alkenyl having 2-18 C atoms and one or more double bonds, straight-chain or branched alkynyl having 2-18 C atoms and one or more triple bonds, saturated, partially or fully unsaturated cycloalkyl having 3-7 C atoms, which may be substituted by alkyl groups having 1-6 C atoms. Examples of such groups have already been mentioned above. In addition, aryl, polyaryl, aryl-C₁-C₆-alkyl or esters having more than 2 C atoms are suitable. The said groups may, in addition, also be substituted, in particular by halogens, where perfluorinated groups are particularly suitable.

Aryl-C₁-C₆-alkyl denotes, for example, benzyl, phenylethyl, phenylpropyl, phenylbutyl, phenylpentyl or phenylhexyl, where both the phenyl ring and also the alkylene chain may be partially or fully substituted by F as described above, particularly preferably benzyl or phenylpropyl.

Examples of suitable hydrophobic olefinically unsaturated monomers for the hydrophobic block B_{hb} are

(1) esters of olefinically unsaturated acids which are essentially free from acid groups, such as alkyl or cycloalkyl esters of (meth)acrylic acid, crotonic acid, ethacrylic acid, vinylphosphonic acid or vinylsulfonic acid having up to 20 carbon atoms in the alkyl radical, in particular methyl, ethyl, propyl, n-butyl, sec-butyl, tert-butyl, hexyl, ethylhexyl, stearyl or lauryl acrylate, methacrylate, crotonate, ethacrylate or vinylphosphonate or vinylsulfonate; cycloaliphatic esters of (meth)acrylic acid, crotonic acid, ethacrylic acid, vinylphosphonic acid or vinylsulfonic acid, in particular cyclohexyl, isobornyl, dicyclopentadienyl, octahydro-4,7-methano-1H-indenemethanol or tert-butylcyclohexyl(meth)acrylate, crotonate, ethacrylate, vinylphosphonate or vinylsulfonate. These may comprise minor amounts of polyfunctional alkyl or cycloalkyl esters of (meth)acrylic acid, crotonic acid or ethacrylic acid, such as ethylene glycol, propylene glycol, diethylene glycol, dipropylene glycol, butylene glycol, pentane-1,5-diol, hexane-1,6-diol, octahydro-4,7-methano-1H-indenedimethanol or cyclohexane-1,2-, -1,3- or -1,4-diol di(meth)acrylate, trimethylolpropane tri(meth)acrylate or pentaerythritol tetra-(meth)acrylate, and the analogous ethacrylates or crotonates. For the purposes of the present invention, minor amounts of polyfunctional monomers (1) are taken to mean amounts which do not result in crosslinking or gelling of the polymers;

(2) monomers which carry at least one hydroxyl group or hydroxymethylamino group per molecule and are essentially free from acid groups, such as
hydroxyalkyl esters of alpha,beta-olefinically unsaturated carboxylic acids, such as hydroxyalkyl esters of acrylic acid, methacrylic acid and ethacrylic acid, in which the hydroxyalkyl group contains up to 20 carbon atoms, such as 2-hydroxyethyl, 2-hydroxypropyl, 3-hydroxypropyl, 3-hydroxybutyl, 4-hydroxybutyl acrylate, methacrylate or ethacrylate; 1,4-bis(hydroxymethyl)cyclohexane, octahydro-4,7-methano-1H-indenedimethanol or methylpropanediol monoacrylate, monomethacrylate, monoethacrylate or monocrotonate; or products of the reaction of cyclic esters, such as, for example, epsilon-caprolactone, and these hydroxyalkyl esters;
olefinically unsaturated alcohols, such as allyl alcohol;
allyl ethers of polyols, such as trimethylolpropane monoallyl ether or pentaerythritol mono-, di- or triallyl ether. The polyfunctional monomers are generally only used in minor amounts. For the purposes of the present invention, minor amounts of polyfunctional monomers are taken to mean amounts which do not result in crosslinking or gelling of the polymers;
products of the reaction of alpha,beta-olefinically unsaturated carboxylic acids with glycidyl esters of an alpha-branched monocarboxylic acid having 5 to 18 carbon atoms in the molecule. The reaction of acrylic or methacrylic acid with the glycidyl ester of a carboxylic acid containing a tertiary alpha-carbon atom can take place before, during or after the polymerisation reaction. The monomer (2) employed is preferably the product of the reaction of acrylic and/or methacrylic acid with the glycidyl ester of Versatic® acid. This glycidyl ester is commercially available under the name Cardura® E10. Reference is additionally made to Römpp Lexikon Lacke and Druckfarben [Römpp's Lexicon of Surface Coatings and Printing Inks], Georg Thieme Verlag, Stuttgart, N.Y., 1998, pages 605 and 606;
formaldehyde adducts of aminoalkyl esters of alpha,beta-olefinically unsaturated carboxylic acids and of alpha,beta-unsaturated carboxamides, such as N-methylol- and N,N-dimethylolaminoethyl acrylate, -aminoethyl methacrylate, -acrylamide and -methacrylamide; and
olefinically unsaturated monomers containing acryloxysilane groups and hydroxyl groups, which can be prepared by reaction of hydroxyl-functional silanes with epichlorohydrin 30 and subsequent reaction of the intermediate with an alpha,beta-olefinically unsaturated carboxylic acid, in particular acrylic acid or methacrylic acid, or hydroxyalkyl esters thereof;

(3) vinyl esters of alpha-branched monocarboxylic acids having 5 to 18 carbon atoms in the molecule, such as the vinyl esters of Versatic® acid, which are marketed under the VeoVa® brand;

(4) cyclic and/or acyclic olefins, such as ethylene, propylene, but-1-ene, pent-1-ene, hex-1-ene, cyclohexane, cyclopentane, norbornene, buta-diene, isoprene, cyclopentadiene and/or dicyclopentadiene;

(5) amides of alpha,beta-olefinically unsaturated carboxylic acids, such as (meth)acrylamide, N-methyl-, N,N-dimethyl-, N-ethyl-, N,N-diethyl-, N-propyl-, N,N-dipropyl-, N-butyl-, N,N-dibutyl- and/or N,N-cyclohexyl-methyl(meth)acrylamide;

(6) monomers containing epoxide groups, such as the glycidyl esters of acrylic acid, methacrylic acid, ethacrylic acid, crotonic acid, maleic acid, fumaric acid and/or itaconic acid;

(7) vinylaromatic hydrocarbons, such as styrene, vinyltoluene or alpha-alkylstyrenes, in particular alpha-methylstyrene;

(8) nitriles, such as acrylonitrile or methacrylonitrile;

(9) vinyl compounds, selected from the group consisting of vinyl halides, such as vinyl chloride, vinyl fluoride, vinylidene dichloride, vinylidene difluoride; vinylamides, such as N-vinylpyrrolidone; vinyl ethers, such as ethyl vinyl ether, n-propyl vinyl ether, isopropyl vinyl ether, n-butyl vinyl ether, isobutyl vinyl ether and vinyl cyclohexyl ether; and vinyl esters, such as vinyl acetate, vinyl propionate and vinyl butyrate;

(10) allyl compounds, selected from the group consisting of allyl ethers and esters, such as propyl allyl ether, butyl allyl ether, ethylene glycol diallyl ether, trimethylolpropane triallyl ether or allyl acetate or allyl propionate; as far as the polyfunctional monomers are concerned, that stated above applies analogously;

(11) siloxane or polysiloxane monomers, which may be substituted by saturated, unsaturated, straight-chain or branched alkyl groups or other hydrophobic groups already mentioned above. Also suitable are polysiloxane macromonomers which have a number average molecular weight Mn of 1000 to 40,000 and contain on average 0.5 to 2.5 ethylenically unsaturated double bonds per molecule, in particular polysiloxane macromonomers which have a number average molecular weight Mn of 2000 to 20,000, particularly preferably 2500 to 10,000 and in particular 3000 to 7000, and contain on average 0.5 to 2.5, preferably 0.5 to 1.5, ethylenically unsaturated double bonds per molecule, as described in DE 38 07 571 A 1 on pages 5 to 7, DE 37 06 095 A 1 in columns 3 to 7, EP 0 358 153 B 1 on pages 3 to 6, in U.S. Pat. No. 4,754,014 A 1 in columns 5 to 9, in DE 44 21 823 A 1 or in International Patent Application WO 92/22615 on page 12, line 18, to page 18, line 10; and

(12) monomers containing carbamate or allophanate groups, such as acryloyloxy- or methacryloyloxyethyl, -propyl or -butyl carbamate or allophanate; further examples of suitable monomers which contain carbamate groups are described in the patent specifications U.S. Pat. No. 3,479,328 A 1, U.S. Pat. No. 3,674,838 A 1, U.S. Pat. No. 4,126,747 A 1, U.S. Pat. No. 4,279,833 A 1 or U.S. Pat. No. 4,340,497 A 1.

The polymerisation of the above-mentioned monomers can be carried out in any way known to the person skilled in the art, for example by polyadditions or cationic, anionic or free-radical polymerisations. Polyadditions are preferred in this connection since different types of monomer can thus be combined with one another in a simple manner, such as, for example, epoxides with dicarboxylic acids or isocyanates with diols.

The respective hydrophilic and hydrophobic blocks can in principle be combined with one another in any desired manner. The amphiphilic silanes in accordance with the present invention preferably have an HLB value in the range 2-19, preferably in the range 4-15. The HLB value is defined here as

$$HLB = \frac{mass of polar fractions}{molecular weight} \cdot 20$$

and indicates whether the silane has more hydrophilic or hydrophobic behaviour, i.e. which of the two blocks Aₕₚ and B_{hb} dominates the properties of the silane according to the invention. The HLB value is calculated theoretically and arises from the mass fractions of hydrophilic and hydrophobic groups. An HLB value of 0 indicates a lipophilic compound; a chemical compound having an HLB value of 20 has only hydrophilic fractions.

The amphiphilic silanes are furthermore distinguished by the fact that at least one reactive functional group is bonded to Aₕₚ and/or B_{hb}. The reactive functional group is preferably located on the hydrophobic block B_{hb}, where it is particularly preferably bonded at the end of the hydrophobic block. In the preferred embodiment, the head group (R)₃Si and the reactive functional group have the greatest possible separation. This enables particularly flexible setting of the chain lengths of blocks Aₕₚ and B_{hb} without significantly restricting the possible reactivity of the reactive groups, for example with the ambient medium.

The reactive functional group can be selected from silyl groups containing hydrolytically removable radicals, OH, carboxyl, NH, SH groups, halogens and reactive groups containing double bonds, such as, for example, acrylate or vinyl groups. Suitable silyl groups containing hydrolytically removable radicals have already been described above in the description of the head group (R)₃Si. The reactive group is preferably an OH group.

The process according to the invention can be carried out as described above. The reaction in the process according to the invention is carried out in an organic solvent or solvent mixture. Preferred solvents are alcohols or ethers, where the use of methanol, ethanol, diethyl ether, tetrahydrofuran and/or dioxane or mixtures thereof is particularly preferred. Methanol has proven to be a particularly suitable solvent.

The reaction temperature can be selected in the range between room temperature and the boiling point of the solvent selected. The reaction rate can be controlled through a suitable choice of the reaction temperature, the starting materials and the concentration thereof and the solvent, so that the person skilled in the art is presented with absolutely no difficulties in controlling the rate in this way. Monitoring of the course of the reaction by UV spectroscopy is possible if desired in order to control the particle size.

In certain cases, it may be helpful if an emulsifier, preferably a nonionic surfactant, is employed. Preferred emulsifiers are optionally ethoxylated or propoxylated, relatively long-chain alkanols or alkylphenols having various degrees of ethoxylation or propoxylation (for example adducts with 0 to 50 mol of alkylene oxide).

Dispersion aids can also advantageously be employed, preference being given to the use of water-soluble, high-molecular-weight organic compounds containing polar groups, such as polyvinylpyrrolidone, copolymers of vinyl propionate or acetate and vinylpyrrolidone, partially saponified copolymers of an acrylate and acrylonitrile, polyvinyl alcohols having various residual acetate contents, cellulose ethers, gelatine, block copolymers, modified starch, low-molecular-weight polymers containing carboxyl and/or sulfonyl groups, or mixtures of these substances.

Particularly preferred protective colloids are polyvinyl alcohols having a residual acetate content of less than 40 mol %, in particular 5 to 39 mol %, and/or vinylpyrrolidone-vinyl propionate copolymers having a vinyl ester content of less than 35% by weight, in particular 5 to 30% by weight.

Adjustment of the reaction conditions, such as temperature, pressure, reaction duration, enables the desired property combinations of the requisite nanoparticles to be set in a targeted manner. The corresponding adjustment of these parameters presents the person skilled in the art with absolutely no difficulties. For example, the reaction can for many purposes be carried out at atmospheric pressure and room temperature.

The nanoparticles according to the invention are used, in particular, for UV protection in polymers. In this application, the particles either protect the polymers themselves against degradation by UV radiation, or the polymer composition comprising the nanoparticles is in turn employed—for example in the form of a protective film or applied as a coating film—as UV protection for other materials. The present invention therefore furthermore relates to the corresponding use of nanoparticles according to the invention for the UV stabilisation of polymers and UV-stabilised polymer compositions essentially consisting of at least one polymer or a surface-coating composition, which is characterised in that the polymer comprises nanoparticles according to the invention.

In the sense of the use of these nanoparticles for UV protection in polymers, it is particularly preferred if the absorption edge of a dispersion is located with, for example, 0.001% by weight of the nanoparticles in the range 300-500 nm, preferably in the range up to 300-400 nm and particularly preferably in the range 320 to 380 nm. It is furthermore particularly preferred in accordance with the invention if the transmission of this suspension (or synonymously also dispersion) with a layer thickness of 10 mm, comprising 0.001% by weight, where the % by weight data is limited by the investigation method, is less than 10%, preferably less than 5%, at 320 nm and greater than 90%, preferably greater than 95% at 440 nm.

For incorporation into polymers, it is essential to use isolated nanoparticles.

The invention therefore also relates to nanoparticies having an average particle size, determined by means of particle correlation spectroscopy (PCS), in the range from 3 to 50 nm, characterised in that they are obtainable by the process according to the invention as described above or defined in the claims, but where the organic solvent is removed to dryness.

The invention accordingly furthermore also relates to a process for the production of isolated nanoparticies of this type, where the organic solvent is removed to dryness in a final step.

Polymers into which the nanoparticles according to the invention can be incorporated well are, in particular, polycarbonate (PC), polyethylene terephthalate (PETP), polyamide (PI), polystyrene (PS), polymethyl methacrylate (PMMA) or copolymers comprising at least a proportion of one of the said polymers

The incorporation can be carried out here by conventional methods for the preparation of polymer compositions. For example, the polymer material can be mixed with isolated nanoparticles according to the invention, preferably in an extruder or compounder.

A particular advantage of the particles according to the invention with a silane coating consists in that only a low energy input compared with the prior art is necessary for homogeneous distribution of the particles in the polymer.

The polymers here can also be dispersions of polymers, such as, for example, surface coatings or surface-coating compositions. The incorporation can be carried out here by conventional mixing operations. The good redispersibility of the particles according to the invention simplifies, in particular, the preparation of dispersions of this type. Correspondingly, the present invention furthermore relates to dispersions of the particles according to the invention in polymers or solvents as dispersion medium.

The surface coatings can be, for example, alkyd resin, chlorinated rubber, epoxy resin, acrylate resin, oil, nitro, polyester or polyurethane coatings or combination coatings based on cellulose nitrate and alkyd resin. The polyurethane coatings have major importance here.

The solvents used in dispersions according to the invention are preferably ether alcohols, aliphatics, alcohols, aromatics, chlorinated hydrocarbons, esters, hydroaromatics, ketones, terpene hydrocarbons and/or water.

The polymer compositions according to the invention comprising the nanoparticles or also the dispersions according to the invention, as described above or defined in Claims 7 and/or 8, are furthermore also suitable, in particular, for the coating of surfaces, for example of wood, plastics, fibres or glass. The surface or the material lying under the coating can thus be protected, for example, against UV radiation.

The following examples explain the present invention in greater detail without restricting the scope of protection. The features, properties and advantages, described in the examples, of the compounds on which the relevant examples are based can, in particular, also be applied to other substances and compounds which are not described in detail, but fall within the scope of protection, unless stated otherwise elsewhere. In addition, the invention can be carried out throughout the range claimed and is not restricted to the examples given here.

### EXAMPLES

Particle Correlation Spectroscopy

The measurements are carried out using a Malvern Zetasizer Nano ZS at room temperature. The measurement is carried out at a laser wavelength of 532 nm.

The sample volume in all cases is 1 ml at a concentration of 0.5 percent by weight of particles in butyl acetate. Before the measurement, the solutions are filtered using a 0.45 μm filter.

Transmission Electron Microscopy

A Fei Company Tecnai 20F with field emission cathode is used. The recordings are made at an acceleration voltage of 200 kV. Data acquisition on a 2k CCD camera from Gatan.

Preparation of Liquid Samples Comprising Nanoparticles for Measurement in the Transmission Electron Microscope

For sample preparation, the solution comprising the nanoparticles is diluted to 1% by weight, and one drop of this solution is placed on a carbon film-coated Cu mesh, and the excess solution is immediately blotted off using a filter paper. The sample is measured after drying at room temperature for one day.

Preparation of Surface-Coating Samples Comprising Nanoparticles for Measurement in the Transmission Electron Microscope

The particle dispersion is mixed with the surface coating so that the ZnO content after drying of the coating layer is 5%. The coating is hardened in a thick layer in a Teflon pan to give self-supporting films with a thickness of at least 2 mm. These samples are ultramicrotomed, without embedding, at room temperature with a 35° diamond knife, cut thickness 60 nm. The cuts are swollen with water and transferred to carbon film-coated Cu meshes and measured.

### Example 1a

### Formation of ZnO Particles

A solution of 0.178 mol of Zn(OAc)₂*2H₂O in 125 ml of methanol is conditioned at 50° C. A solution, likewise conditioned at 50° C., of 0.288 mol of K[OSi(CH₃)₃] in 125 ml of methanol is added with stirring.

The conversion to zinc oxide and the growth of the nanoparticles can be followed by UV spectroscopy. After a reaction duration of only one minute, the absorption maximum remains constant, i.e. the ZnO formation is already complete in the first minute.

A stable, transparent suspension is obtained which, according to UV spectroscopy and X-ray diffraction, comprises ZnO. The diameter of the particles, according to investigation by particle correlation spectroscopy using a Malvern (PCS) Zetasizer Nano ZS, is 4-12 nm with a d50 of 6-7 nm and a d90 of 5-10 nm. The size is thus in the region below 15-20 nm, as is necessary for transparent applications. The particles produced in this way are stable for several hours, enabling them to be functionalised further.

A comparative experiment with KOH instead of K[OSi(CH₃)₃] as base (Example 3) shows continued particle growth, evident from the fact that the solution becomes cloudy after a few minutes and a sediment of precipitated-out zinc oxide particles finally forms. This sediment can easily be filtered off, and the size of the particles or agglomerates thereof is thus significantly above the target size of less than 15-20 nm.

### Example 1b

### Modification by Subsequent Silanisation

After stirring at 50° C. for 30 min, 8.0 mmol of hexadecyltrimethoxysilane are added to the dispersion from Example 1a. The mixture is stirred at 50° C. for 5 h. The hydrophobic particles are separated off by shaking with pentane or petroleum ether.

A stable, transparent suspension is obtained which, according to UV spectroscopy and X-ray diffraction, comprises ZnO. Furthermore, no potassium acetate reflections are visible in the X-ray diagram. The diameter of the particles, according to investigation by photon correlation spectroscopy using a Malvern (PCS) Zetasizer Nano ZS, is 4-12 nm with a d50 of 6-7 nm and a d90 of 5-10 nm.

Re-measurement after 10 days gives the same values within the bounds of measurement accuracy. Agglomeration of the particles can thus be excluded.

### Example 1c

### In-Situ Generation of K[OSiMe₃]

2 mol of zinc acetate dihydrate are initially introduced in 1650 ml of methanol, and the suspension is warmed to 50° C. Separately, 3.3 mol of potassium hydroxide are dissolved completely in 650 ml of methanol, and 3.3 mol of trimethylethoxysilane are subsequently added with stirring, and the mixture is stirred for a further 1 hour. This solution is added with stirring to the zinc acetate suspension, and the reaction time is measured from this point. The progress of the reaction is followed by UV/VIS spectrometer. When the desired absorption edge has been reached, 0.08 mol of hexadecyltrimethoxysilane is added, and the mixture is stirred at 50° C. for 5 hours. 1500 ml of ligroin are then added to the reaction mixture.

A stable, transparent suspension is obtained which, according to UV spectroscopy and X-ray diffraction, comprises ZnO. Furthermore, no potassium acetate reflections are visible in the X-ray diagram. The diameter of the particles, according to investigation by photon correlation spectroscopy using a Malvern (PCS) Zetasizer Nano ZS, is 4-12 nm with a d50 of 6-7 nm and a d90 of 5-10 nm.

Re-measurement after 10 days gives the same values within the bounds of measurement accuracy. Agglomeration of the particles can thus be excluded.

### Example 2a

### Modification by Addition of TMOS

After 30 min, 8.0 mmol of tetramethyl orthosilicate (TMOS) are added to the dispersion from Example 1a, and stirring is continued at 50° C.

A stable, transparent suspension is obtained which, according to UV spectroscopy and X-ray diffraction, comprises ZnO. The diameter of the particles, according to investigation by particle correlation spectroscopy using a Malvern (PCS) Zetasizer Nano ZS, is 4-12 nm with a d50 of 6-7 nm and a d90 of 5-10 nm.

### Example 2b

### Modification by Addition of TMOS and Subsequent Silanisation

After 60 min, 10.0 mmol of hexadecyltrimethoxysilane are added at 50° C. with stirring to the suspension described in Example 2a. The mixture is stirred at 50° C. for 5 h. The hydrophobic particles are separated off by shaking with pentane or petroleum ether.

A stable, transparent suspension is obtained which, according to UV spectroscopy and X-ray diffraction, comprises ZnO. Furthermore, no potassium acetate reflections are visible in the X-ray diagram. The diameter of the particles, according to investigation by photon correlation spectroscopy using a Malvern (PCS) Zetasizer Nano ZS, is 4-12 nm with a d50 of 6-7 nm and a d90 of 5-10 nm.

Re-measurement after 10 days gives the same values within the bounds of measurement accuracy. Agglomeration of the particles can thus be excluded.

### Comparative Example 3

### Preparation of ZnO Using KOH

A solution of 0.4 mol of Zn(OAc)₂*2H₂O in 250 ml of methanol is conditioned at 50° C. A solution, likewise conditioned at 50° C., of 0.680 mol of KOH in 250 ml of methanol is added with stirring.

The conversion to zinc oxide and the growth of the nanoparticles can be followed by UV spectroscopy. After only 10 minutes, a white precipitate of zinc oxide precipitates out. The reaction is continued for 5 hours. The precipitate is washed with methanol.

A white suspension is obtained which, according to X-ray diffraction, comprises ZnO. Furthermore, no potassium acetate X-ray reflections are visible.

### Example 4

### Measurement of the Photocatalytic Activity

The model substance to be degraded is isopropanol, which is oxidised to CO₂ on photoactive surfaces via the intermediate acetone in the presence of steam and oxygen with irradiation. The rate of this reaction is regarded as a measure of the photoactivity of the respective substance investigated. 1.58 g of each of the substances, i.e. ZnO from Example 1b, 2b or 3, are added directly to a Petri dish by means of an upright sieve (diameter 5 cm, 127 mesh) with the aid of a fine brush. The intensity of the UV-A radiation acting on this substance is set to 15 mW/cm² immediately before the investigation. After the sample to be investigated for photocatalytic activity has been placed in the reactor, the apparatus is flushed carefully with the carrier gas (synthetic air), and a defined water gas concentration is set in through-flow operation via the humidifier (metering rate 1800 μl/h to 10,000 ppm). After switching to circulation operating mode, precisely 1 μl of isopropanol is injected through the septum into the gas space, which is continuously circulated by the pump. After the adsorption/desorption equilibrium between the sample surface and gas phase has become established, the irradiation is switched on. The potential degradation of the components to be oxidised and their secondary products can be followed quantitatively from the spectra recorded continuously by the FTIR. The software of the computer connected to the FTIR evaluates the respective experimental spectrum as the sum of the reference spectra of species involved in the degradation process. The concentration of each individual component in the gas phase can be calculated from the proportions of their intensity in the experimental spectrum. The difference in the concentrations before and after irradiation is a measure of the photocatalytic degradation.

TABLE
Difference value from the measured gas-phase concentrations of
acetone before and after irradiation of the samples at 15 mW/cm²
for 45 minutes

| Sample | Substance | Δc (acetone)/ppm |
|---|---|---|
| 1 | ZnO (Ex. 3) | 77.37 |
| 2 | ZnO (Ex. 1b) | 40.32 |
| 3 | ZnO (Ex. 2b) | 2.9 |

The ZnO from Example 2b (sample 3) exhibits the lowest photocatalytic activity.

### Example 5

Preparation of a Polymer Nanocomposite

The suspension from Example 2b is evaporated to dryness under reduced pressure. A fine, free-flowing powder comprising surface-modified zinc oxide is obtained.

10 g of these particles are mixed with 1 kg of PMMA (polymethyl methacrylate, PMMA moulding composition 7H from Degussa Röhm) in the extruder, and 10 g of the resultant granules are re-extruded with 100 g of the same polymer. The nanocomposite obtained is converted into plates with a thickness of 1.5 mm by injection moulding. These are transparent and exhibit <5% transmission at 350 nm, >90% transmission at 450 nm, measured in a UV/VIS spectrometer.

### Example 6

### Incorporation Into Surface Coating

Preparation of a Surface-Coating Composition Comprising ZnO Nanoparticles

Two components are prepared by mixing the following constituents:

Component A

46.39 g of Desmophen A 870 BA, 70% in butyl acetate (Bayer)

0.5 g of Baysilone® coating additive OL 17, 10% in xylene (Borchers GmbH)

14.67 g of a 1:1 mixture of 1-methoxypropyl 2-acetate and solvent naphtha 100 (DHC Solvent-Chemie GmbH)

12.5 g of ZnO dispersion from Example 2b

Component B

9.98 g of Desmodur N 3390 BA/SN, 90% in butyl acetate/solvent naphtha 100 (1:1) (Bayer)

12.83 g of Desmodur Z 4470 BA, 70% in butyl acetate (Bayer)

Components A and B are mixed and applied to a glass plate in a layer thickness of 200 μm by means of a doctor blade. After a drying time of 10 minutes at RT, the coating is cured at 130° C. for 30 min, giving an optically transparent, colourless coating layer with a thickness of about 100 μm.

In the UV spectrum, this layer exhibits a transmission of greater than 95% at 400 nm and less than 5% at 350 nm.

1. Nanoparticles having an average particle size, determined by means of particle correlation spectroscopy (PCS), in the range from 3 to 50 nm, dispersed in an organic solvent, characterised in that they are obtainable by a process in which one or more precursors of the nanoparticles are reacted with a compound M₃₋ₓ[O₃₋ₓSiR₁₊ₓ] in an organic solvent to give the nanoparticles, where x stands for an integer selected from 0, 1 or 2, M stands for H, Li, Na or K, and all R each, independently of one another, stand for a branched or unbranched, saturated or unsaturated hydrocarbon radical having 1 to 28 C atoms, in which one or more C atoms may be replaced by O.

2. Nanoparticles according to claim 1, characterised in that the nanoparticles are particles essentially consisting of oxides or hydroxides of silicon, cerium, cobalt, chromium, nickel, zinc, titanium, iron, yttrium, zirconium or mixtures thereof.

3. Nanoparticles according to claim 1, where the particles are preferably zinc oxide or cerium oxide particles or mixed oxide particles comprising at least one of these constituents.

4. Nanoparticles according to claim 1, characterised in that the particles have an average particle size, determined by means of particle correlation spectroscopy (PCS), of 5 to 20 nm.

5. Nanoparticles according to claim 1, characterised in that the particles have a further surface modification, which is preferably a silica coating and/or a hydrophobic modification.

6. Nanoparticles according to claim 1, characterised in that the particles having a silica coating have additionally been modified by means of at least one further surface modifier selected from the group of organofunctional silanes, quaternary ammonium compounds, phosphonates, phosphonium and sulfonium compounds or mixtures thereof, preferably an organofunctional silane.

7. Nanoparticles according to claim 1, characterised in that the nanoparticles have been modified by means of at least one organofunctional silane.

8. Dispersion comprising nanoparticles according to claim 1 and a polymer.

9. Dispersion according to claim 8, characterised in that the dispersion is a surface coating or a surface-coating composition.

10. Process for the production of nanoparticles having an average particle size in the range from 3 to 50 nm, dispersed in an organic solvent, characterised in that one or more precursors of the nanoparticles are reacted with a compound M₃₋ₓ[O₃₋ₓSiR₁₊ₓ] in an organic solvent to give the nanoparticles, where x stands for an integer selected from 0, 1 or 2, M stands for H, Li, Na or K, and all R each, independently of one another, stand for a branched or unbranched, saturated or unsaturated hydrocarbon radical having 1 to 28 C atoms, in which one or more C atoms may be replaced by O.

11. Process according to claim 10, characterised in that the one or more precursors are selected from water-soluble metal compounds, preferably silicon, cerium, cobalt, chromium, nickel, zinc, titanium, iron, yttrium or zirconium compounds, preferably from the zinc salts of carboxylic acids or halides.

12. Process according to claim 10, characterised in that the compound M₃₋ₓ[O₃₋ₓSiR₁₊ₓ], where M stands for Li, Na or K, and x and R have a meaning indicated in claim 10, is generated in situ from a base MOH and a compound R′₃₋ₓ[O₃₋ₓSiR₁₊ₓ], where R′ denotes an alkyl group having 1 to 16 C atoms.

13. Process according to claim 10, characterised in that at least one R in the compound M₃₋ₓ[O₃₋ₓSiR₁₊ₓ] stands for an alkoxy radical having 1 to 27 C atoms, preferably a methoxy or ethoxy radical.

14. Process according to claim 10, characterised in that, in the compound M₃₋ₓ[O₃₋ₓSiR₁₊ₓ], x stands for 2 and all R each, independently of one another, stand for methyl or ethyl.

15. Process according to claim 10, characterised in that all R stand for methyl, and M stands for K.

16. Process according to claim 10, characterised in that, in a further reaction step, at least one modifier for the production of a silica coating or a surface modifier for the production of a hydrophobic shell is added.

17. Process according to claim 10, characterised in that the modifier for the production of the silica coating is a trialkoxysilane or a tetraalkoxysilane.

18. Process according to claim 10, characterised in that, after the application of a silica coating, at least one surface modifier is added in a further reaction step, where the modifier is preferably an organofunctional silane, quaternary ammonium compound, phosphonate, phosphonium or sulfonium compound.

19. Process according to claim 10, characterised in that the surface modifier is an organofunctional silane.

20. Process according to claim 10, characterised in that the surface modifier is an amphiphilic silane of the general formula (R)₃Si—S_{P}-Aₕₚ-B_{hb}, where the radicals R may be identical or different and represent hydrolytically removable radicals, S_{P} denotes either —O— or straight-chain or branched alkyl having 1-18 C atoms, straight-chain or branched alkenyl having 2-18 C atoms and one or more double bonds, straight-chain or branched alkynyl having 2-18 C atoms and one or more triple bonds, saturated, partially or fully unsaturated cycloalkyl having 3-7 C atoms, which may be substituted by alkyl groups having 1-6 C atoms, Aₕₚ denotes a hydrophilic block, B_{hb} denotes a hydrophobic block, and where at least one reactive functional group is preferably bonded to Aₕₚ and/or B_{hb}.

21. Process according to claim 10, characterised in that the organic solvent is selected from alcohols or ethers.

22. Process according to claim 10, characterised in that an emulsifier, preferably a nonionic surfactant, is employed.

23. Nanoparticles having an average particle size, determined by means of particle correlation spectroscopy (PCS), in the range from 3 to 50 nm, characterised in that they are obtainable by a process according to claim 10, but where the organic solvent is removed to dryness.

24. Process for the production of nanoparticles having an average particle size, determined by means of particle correlation spectroscopy (PCS), in the range from 3 to 50 nm, characterised in that they are produced by a process according to claim 10, where the organic solvent is removed to dryness in a final step.

25. A method of using nanoparticles according to claim 1 comprising employing said nanoparticles for the UV stabilisation of polymers.

26. Polymer composition essentially consisting of at least one polymer, characterised in that the polymer comprises nanoparticles according to claim 23.

27. Polymer composition according to claim 26, characterised in that the polymer is polycarbonate (PC), polyethylene terephthalate (PETP), polyimide (PI), polystyrene (PS), polymethyl methacrylate (PMMA) or copolymers comprising at least a proportion of one of the said polymers.

28. Process for the preparation of polymer compositions according to claim 26, characterised in that the polymer material is mixed with nanoparticles, preferably in an extruder or compounder.

29. Wood treated with a dispersion according to claim 8.

30. Plastic treated with a dispersion according to claim 8.

31. Fibre treated with a dispersion according to claim 8.

32. Glass treated with a dispersion according to claim 8.

33. Plastic comprising a polymer composition according to claim 26.

34. Fibre comprising a polymer composition according to claim 26
